(19) United States
(12) Patent Application Publication
(10) Pub. No.: US 2008/0030854 A1
(43) Pub. Date: Feb. 7, 2008

(54) Application of retroreflective tapes to garments

(76) Inventors: David Hews, Belchertown, MA (US); Maurice Brady, Waterford (IE); Ian Christopher, Vernon, CT (US); Andrew Woodward, Bowdon (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/881,412

(22) Filed: Jul. 26, 2007

Related U.S. Application Data
(60) Provisional application No. 60/834,089, filed on Jul. 28, 2006.

(51) Int. Cl. G02B 5/124; C09J 5/06

(52) U.S. Cl. 359/518; 156/307.3

(57) ABSTRACT

Techniques for adhering metal backed cube corner Retroreflective tapes to a variety of fabric types, such as Gortex™, by applying a thermoset adhesive to the back of the tape at temperatures below the activation temperature (e.g., at about the melt temperature), and then subsequently applying the tape to the garment at temperatures above the adhesive activation temperature. This permits adhesive bonding to both the fabric and the tape at the same time, which in turn provides improved performance through numerous wash and wear cycles.

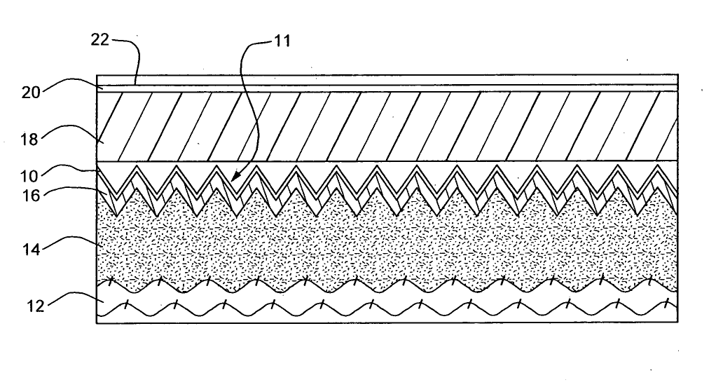

### RELATED APPLICATION(S)

This application claims the benefit of U.S. Provisional Application No. 60/834,089, filed on Jul. 28, 2006. The entire teachings of the above application(s) are incorporated herein by reference.

### BACKGROUND OF THE INVENTION

Retroreflective materials are now often applied to the garments used by police, firefighters, rescue workers and many other personnel to provide nighttime visibility. The retroreflective tapes used for these applications are either sewn onto the garment or adhered to the garment using a Heat Activated Adhesive (HAA).

The retroreflective media used for HAA systems can be broadly classified into two major types, including glass bead and metal backed cube corner retroreflective. Glass bead systems are ineffective in wet conditions and the retroreflective elements are exposed to the same during normal wash and wear cycles. Metal-backed cube corner systems contain retroreflective elements that are completely encapsulated between the adhesive and the flexible carrier film. Thus, these systems are generally expected to provide better wet performance.

Some have suggested methods of applying a thermoplastic heat activated transfer layer to a cloth substrate. The thermoplastic layer is set against a substrate, such as a cloth shirt, and a piece of blotting paper or other absorbent material is placed above the transfer in contact with the thermoset layer. Heat and pressure are then applied to melt the thermoplastic layer (for example, U.S. Pat. No. 4,786,349). To date, however, the range of fabrics that can be used in such systems has been limited by the ability of the thermoplastic layer to remain adhered to the garment through multiple wear and tear and washing cycles.

Other methods have suggested using thermoplastic polyurethane along with a pressure sensitive adhesive to provide a low temperature tack of HAA. However, there appears to be no use of such adhesive systems in application to cloth substrates. (See for example, International Patent Publication WO 01/34716 A1).

Therefore, known methods for attaching retroreflective materials to fabrics are less than ideal, as they involve either inserting a thermoplastic adhesive layer that can leave voids and/or require absorbing sheets to remove excess thermoplastic.

### SUMMARY OF THE INVENTION

The present invention can be used to securely adhere cube corner retroreflective tapes to a variety of desirable fabric types. A method according to the invention involves applying a thermoset adhesive to the back of the retroreflective tape, at a temperature below the activation temperature of the thermoset adhesive. A subsequent application of the tape is made to a garment, and then subjected to temperatures above the adhesive activation temperature. With this approach the adhesive bonds to both the fabric and the tape substrate at the same time.

The invention has been observed to provide several advantages. The tape remains attached to popular fabric types through numerous wash and wear cycles. In particular, the process allows the adhesive to stick to Gortex™ treated fabrics where other systems have been known to fail. (Goretex is a trademark of W. L. Gore & Associates of Newark, Del.). Since the current invention works well with metal backed cube corner retroreflective elements, the design is not susceptible to abrasion or wet performance problems associated with glass bead systems.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

The single FIGURE is a cross sectional diagram of a garment having a metalized retroreflective layer applied thereto via a thermoset adhesive according to the invention.

### DETAILED DESCRIPTION OF THE INVENTION

A description of preferred embodiments of the invention follows.

As shown in the single FIGURE, the present invention results in an optical film including light-redirecting or retroreflective elements 11, such as a metal backed cube corner film (tape) 10, being applied to a garment fabric 12 substrate using a thermoset adhesive 14. Generally speaking, the thermoset adhesive 14 is applied to a metallization layer 16 on the back of the tape 10 at temperatures below the activation temperature and pressure, but at or above the melt temperature and pressure, of the thermoset adhesive. Subsequent application of the tape 10 is made to the garment 12 at a temperature and pressure above thermoset activation point. This permits the adhesive 14 to bond to both the underlying garment fabric 12 and the tape 10 at the same time. The process has been found to work particularly well with Gortex™ treated fabrics and other stain resistant coatings over numerous wash and wear cycles.

More particularly, as one example, a cube corner retroreflective tape 10 is provided having a construction consisting of several cured light-redirecting or retroreflective structural elements 11 that can contain, for example, linear or cube-corner prisms. Examples of suitable cube-corner prisms are disclosed in U.S. Pat. No. 3,684,348 issued to Rowland on Aug. 15, 1972, U.S. Pat. No. 3,689,346 issued to Rowland on Sep. 5, 1972, and U.S. Pat. No. 3,712,706, issued to Stamm on Jan. 23, 1973, the teachings of all of which are incorporated by reference herein.

As described in those patents generally, cube-corner prisms 11 can be made by forming a master negative die on a flat surface of a metal plate or other suitable material. To form the cube-corners, a series of parallel equidistance intersecting grooves are inscribed in the flat plate. The die is then used to process the desired cube-corner array into a rigid flat plastic surface. Also, the pattern transfer concept can include forming a structured coating onto a smooth surface and also forming a pattern structure onto a micro optical array of any type including submicron to micron size surfaces. The pattern can be random, ordered or designed to convey a message.

As also described in those prior art patents, the cube corner retroreflective prisms 11 are formed from a high temperature stability resin. For the purposes of the present invention, the resin used for forming the retroreflective prisms 111 should be heat and dimensionally stable to at least expected thermoset temperature of the thermoset adhesive 14. It will be understood shortly this may be in the range of 210 degrees Centigrade (° C.) or even higher temperatures, depending upon the exact adhesive 14 chosen and pressures that can be applied by available equipment.

The retroreflective tape 10 may typically also include a lower metal reflective layer 16 and outer (upper) polyvinyl chloride (PVC) film layer 18. The metal layer 16 provides a mirror surface to reflect light. The upper PVC layer 18 provides increased substrate flexibility, which is a desirable characteristic in garment applications.

A thermoset adhesive is then applied to the bottom of the retroreflective tape 10. In a preferred embodiment, the adhesive 14 may be the heat reactive thermosetting transfer adhesive known as H194 ULT and/or H206 U available from Scapa North America, of Windsor, Conn.

The cloth 12 is then applied to the remaining exposed side of the adhesive 14, and then thermoset by applying the required temperature and/or pressure. This then allows the adhesive 14 to set to both the reflective tape 10 and the cloth 12 at the same time.

The adhesive application and activation steps can be performed via a suitable continuous process machine such as a belt and roller press, at speeds up to about 6 meters per minute for the application step, and preferably about 2.3 to 2.4 meters per minute for the activation step. Alternatively, these steps can be performed by a discrete step flat press.

### DETAILED PROCESS EXAMPLE 1

In one example embodiment, the process began with a retroreflective tape 10 having a protective layer 20 already formed (or sealed) on one side thereof. Polyethylene terephthalate (aka PET) or other thermoplastic polymer resin of the polyester family can be used for the protective layer 20.

A next step was to apply the adhesive 14 to the exposed metal 16 side (the side opposite the protective layer 20) of the tape 10. The adhesive was applied using a hot lamination roll process at a line speed of about 20 feet per minute (about 6 meters per minute), a rotating nip roll pressure of about 150 pounds per square inch (psi) (about 103 Newtons per square centimeter (N/cm²)), and temperature of about 170° F. (about 75° C.). Infrared heaters were arranged to preheat the retroreflective sheeting during this step.

This initial application of the adhesive 14 was thus made to the retroreflective tape without yet causing the adhesive to finally set. The exact temperature and pressure conditions for this initial “melt” adhesive application step are not considered critical, as long as they are less than that required to activate the adhesive. It is known that the particular Scapa H206 U thermoset adhesive 14 used in this example has a melt temperature of 120° C. with no pressure applied, and a thermoset temperature of 210° C. with no pressure applied. This initial adhesive application step, typically carried out at an elevated pressure (e.g., 150 psi (103 N/cm²)), can thus be carried out at a somewhat lower temperature than the zero pressure melt temperature.

The resulting tapes having the applied adhesive 16 were then applied to several fluoropolymer treated cloths 12, including Sympatec, Gortex Y and Gortex O treated cloths.

A second adhesive activation step then subjected the product to a set of conditions sufficient to thermoset the adhesive 14. This second step was carried out at a temperature of about 266° F. (about 130° C.), an application pressure of approximately Newtons per centimeter squared (N/cm²) (about 14 psi), and at a speed of 7.5 ft/min (2.3 m/min) on the roller press.

This second activation step was then a set of conditions (application of heat and pressure) sufficient to cause the adhesive 14 to thermoset, and thus to cause the adhesive to be bonded (sealed) to both the fabric 12 and the tape 16 substrate at the same time.

It should be understood that higher application temperatures (up to 170° C.) could also be used to set the same adhesive, but with different pressure and roller speed conditions. Also, different adhesives would potentially require different activation conditions. What is important is that the adhesive reach its activation temperature not during the first step, but only during the second step, after the adhesive has been applied to both the fabric 12 and the tape.

It is important also to select a set of adhesive application conditions that do not affect the optical properties of the retroreflective elements. The optical performance of the resulting construction was thus tested, both before and after application of the tapes to the cloth. Specifically, the retroreflective tape 10 samples were first tested to confirm their optical conformance to European Standard EN471. The tape samples 10 were then adhered to cloth 12 substrates, using the above two-step adhesive activation process. Conformance to EN471 was then measured again, to confirm that the retroreflective tape 10 also adequately withstood the application of heat and pressure to activate the adhesive.

The samples were then repeatedly washed and dried, through at least 30 cycles, following ISO 15797 Method 2 conditions. Their conformance to EN471 after these wash/dry cycles was then again measured, to confirm the durability and wearability of the construction.

### OPTIONAL EMBODIMENTS

One optional step is to remove the protective layer 20 on to the retroreflective film 18 prior to final activation of the adhesive.

In another optional embodiment, an optional ink layer 22 may then be applied to the exposed top surface of the retroreflective film 18, just after the protective layer 20 is removed. The ink layer 22 typically defines printed words, designs, or other indicia (e.g., a badge) for the finished article. If so desired, it is preferred that the ink layer 22 be applied just prior to the final heating step that fixes the adhesive to both the cloth and the tape substrate simultaneously.

Various types of machines can be used to implement the process such as flat or belt and roller heat presses operating at speeds different from those stated in the specific example above.

While this invention has been particularly shown and described with references to preferred embodiments thereof, it will be understood by those skilled in the art that various changes in form and details may be made therein without departing from the scope of the invention encompassed by the appended claims. For example, it will be understood that for different desired roller press line speeds, that different temperatures and/or pressures should be applied to activate a given thermoset adhesive.

What is claimed is:

1. A method comprising the steps of
providing a film having retroreflective elements formed therein;
applying a thermoset adhesive to one side of the retroreflective film at a temperature below an adhesive activation temperature, to produce an adhesive backed tape;
applying the adhesive backed tape to a fabric substrate; and
activating the thermoset adhesive, by subjecting both the adhesive backed tape and fabric substrate simultaneously to a temperature and pressure sufficient to cause activation of the thermoset adhesive.

2. A method as in claim 1 wherein the thermoset adhesive is activated at a range of temperatures between about 130 and 210 degrees Centigrade.

3. A method as in claim 1 wherein the thermoset adhesive is activated within a range of pressure between 0 and 20 Newtons per square centimeter.

4. A method as in claim 1 wherein thermoset adhesive is initially adhered to the fabric substrate by feeding the adhesive coated retroreflective film and fabric substrate through a roller heat press at a speed of up to about 6 meters per minute.

5. A method as in claim 1 additionally comprising:
applying a protective layer to the retroreflective film prior, to the step of applying the thermoset adhesive.

6. A method as in claim 5 wherein the protective layer is formed from PET.

7. A method as in claim 5 additionally comprising:
removing the protective layer, after the step of applying the thermoset adhesive.

8. A method as in claim 1 additionally comprising:
applying a printed indicia to the retroreflective film, prior to activating the thermoset adhesive.

9. An article comprising:
a film having a plurality of retroreflective elements;
a fabric substrate; and
a thermoset adhesive disposed between the film and the fabric substrate, the thermoset adhesive having a melt temperature less than an activation temperature, such that the adhesive has been applied to one of the film or the fabric substrate first, prior to activation of the adhesive to both the film and the fabric substrate at the same time.

10. The article of claim 9 wherein the thermoset adhesive has an activation temperature in a range of between about 130 and 210 degrees Centigrade.

11. The article of claim 9 wherein the thermoset adhesive has an activation pressure at a range of between 0 and 20 Newtons per square centimeter.

12. The article of claim 9 additionally comprising:
an indicia printed on the retroreflective film.
